(19) United States
(12) Patent Application Publication
(10) Pub. No.: US 2010/0314963 A1
(43) Pub. Date: Dec. 16, 2010

(54) PERMANENTLY EXCITED ELECTRICAL MACHINE

(76) Inventors: Andreas Gruendl, Starnberg (DE); Bernhard Hoffmann, Starnberg (DE)

Correspondence Address: HISCOCK & BARCLAY, LLP, 2000 HSBC PLAZA, 100 Chestnut Street, ROCHESTER, NY, 14604-2404, US

(21) Appl. No.: 12/743,155

(22) PCT Filed: Nov. 12, 2008
(86) PCT No.: PCT/EP2008/009546

§ 371 Date: Sep. 1, 2010

(30) Foreign Application Priority Data
Nov. 15, 2007 (DE) 10 2007 056 116.6

(51) Int. Cl. H02K 21/22; H02K 17/16; H02K 1/27

(52) U.S. Cl. 310/156.07; 310/210; 310/191

(57) ABSTRACT

The invention relates to a permanently-excited electrical machine with a stator and a rotor. The stator has a coil arrangement and the rotor is provided with permanent magnet elements, or the rotor comprises a coil arrangement and the stator is provided with permanent magnet elements. An air gap is formed between the stator and the rotor, which is defined by the permanent magnet elements and magnetically conductive teeth of the stator, which are aligned with these in certain positions. The coil arrangement comprises at least one hollow cylindrical winding which is at least partially accommodated in the stator. The rotor has a magnetic return on the sides of the permanent magnet elements, which are remote from the air gap. The magnetic return is formed of rings which are oriented in the circumferential direction of the rotor, and which in the axial direction of the rotor are not wider than individual ones of the permanent magnet elements. Electrically/magnetically effective short-circuit coils are arranged between neighbouring permanent magnet elements in the axial direction of the electrical machine and/or neighbouring magnetic return rings in the axial direction.

### BACKGROUND

In the following, a permanently excited electrical machine will be described. In particular, the invention relates to a transversal flow machine with a stator and a rotor, wherein either the stator comprises a stator coil and the rotor is provided with permanent magnet elements, or the rotor comprises a rotor coil and the stator is provided with permanent magnet elements.

### DEFINITION OF TERMS

The term “electrical machine” as used herein covers both motors and generators which may be designed as rotating machines or, for example, as linear motors. In connection with rotating machines, this concept may be employed both for internal rotor machines and external rotor machines.

### STATE OF THE ART

From EP 0 952 657 A2 a transversal flow machine with a stator arrangement in a stator housing is known, in which a pole system with a U-shaped cross-section, which extends in the rotating direction is arranged. In the recess between the legs of the U-shaped cross-section, an annular winding is arranged which extends in the rotating direction. A rotor arrangement comprises rows of alternately arranged permanent magnets and soft iron magnetic flux return elements. On the stator side, a support ring each is provided between the annular winding and the rotor arrangement, which comprises recesses in both marginal areas for the accommodation of teeth of the pole system, which project in the direction of the rotor arrangement. The support ring serves to stabilise the pole system and the annular coil. Each pole system consists of an annular pole yoke and two pole rings which are arranged adjacent in the lateral areas of same.

DE 195 47 159 A1 shows a transversal flow machine with conductor rings which are encompassed on three sides by U-shaped, soft magnetic bodies, with a magnetic circuit of hard and/or soft magnetic parts being closed periodically. These parts are separated from the respective U-shaped, soft magnetic body by two air gaps which are provided radially outside the conductor rings. The magnetically active parts of the rotor or stator are partially arranged axially within the ends of the U-shaped soft magnetic bodies.

DE 20 2005 019 162 discloses a motor with an annular ferromagnet which comprises a non-magnetic outer area and a magnetic inner area. In particular, this arrangement has an annular anisotropic multipole permanent magnet which is oriented towards the centre, with its number of poles being in reverse proportion to the speed. The anisotropic multipole permanent magnet has a non-magnetic outer area and a magnetic inner area. The non-magnetic outer area interfere with the magnetic lines of force of the magnetic inner area so that the magnetic circuits become smaller thereby increasing the magnetic flux which results in a higher motor power. With conventional magnets consisting of NdFeB or the crescent-shaped ferromagnets, the magnetic circuits are larger, so that the loss of the magnetic lines of force is very high and the motor power is reduced.

EP 0 821 464 describes a rotor which is formed of glass or carbon fibre material, and in which magnetisable material is embedded in an imaginary inner shell.

From EP 0 998 010 it is known to arrange a damper cage made of a material with high electrical conductivity and low magnetic conductivity at the rotor of a transversal flow machine, which at least partially encompasses the permanent magnets and flux conductors. The damper cage is formed by webs which, when viewed in the direction of the stator, are arranged above the permanent magnets and between the flux conductors, and by connecting pieces for interconnecting the webs. In the transversal flow machine with flux concentration, the permanent magnets may be made smaller. The flux conductors are made from iron or iron alloys, respectively, or as sintered parts containing iron. The flux conductors may also be built from laminations.

### Basic Problem

The object is to provide a compact and highly efficient electrical machine which permits a high power density with an optimised construction for series production and is suited, in particular, for high speed.

### Solution

As the solution, an electrical machine of the transversal flow machine type with a stator and a rotor is proposed, wherein the stator comprises a coil arrangement and the rotor is provided with permanent magnet elements. Between the stator and the rotor, an air gap is formed, which is defined by the permanent magnet elements and by magnetically conducting teeth of the stator, which in certain positions are oriented towards them. The coil arrangement comprises at least one hollow cylindrical winding which is at least partially accommodated in the stator. On the side of the permanent magnet elements remote from the air gap, the rotor is provided with a magnetic return. The magnetic return is formed from rings which are oriented in the circumferential direction, and which in the axial direction are not wider than individual ones of the permanent magnet elements. Magnetically effective short-circuit coils are arranged between permanent magnet elements which are neighbouring in the axial direction of the electrical machine and/or in rings of the magnetic return, which are neighbouring in the axial direction.

These magnetically effective short-circuit coils are particularly effective at high speeds against the magnetic field component which undesirably develops in the axial direction through the stator coils, but which does not contribute to the force generation. This axial component may cause eddy currents with correspondingly high losses in the rotor-carrying structure. Due to the material with a good electrical conductivity, these eddy currents are carried in a low-loss manner through the short-circuit coils, and effectively shield the rotor-carrying structure against eddy current.

In an alternative of the permanently excited electrical machine of the transversal flow machine type with a stator and a rotor, the stator comprises a coil arrangement and the rotor is provided with permanent magnet elements. Between the stator and the rotor an air gap is formed, which is defined by the permanent magnet elements and by magnetically conducting teeth of the stator, which in certain positions are oriented towards them. The coil arrangement comprises at least one preferably annular hollow cylindrical winding which is at least partially accommodated in the stator. The rotor comprises (i) a magnetically non-effective support structure for the permanent magnet elements and (ii) the permanent magnet elements. In other words, the rotor is free from any magnetic flux return material. Rather, the magnetic orientation of the rotor magnets is modelled in such a manner, that a sufficiently high permanent excitation field is generated in the air gap in spite of a missing soft iron magnetic return. Due to the possible omission of the soft iron magnetic return, the undesired, because not contributing to the force generation, development of the magnetic flux in the axial direction is avoided.

Thereby, the maximum utilisation of the volume in the electrical machine at very high operation reliability and low manufacturing costs is achieved. Moreover, the improved space utilisation increases the efficiency or the power density of the machine.

In another variant of a permanently excited electrical machine transversal flow machine type with a stator and a rotor in an external rotor configuration, the stator has a coil arrangement and the rotor is provided with permanent magnet elements. Between the stator and the rotor an air gap is formed, which is defined by the permanent magnet elements and by magnetically conducting teeth of the stator, which in certain positions are oriented towards them.

The coil arrangement has at least one preferably annular hollow cylindrical winding which is at least partially accommodated in the stator. The rotor is designed in such a manner that at high rotor speeds it undergoes a deformation in the radial direction in the sense of an increase of the air gap. This measure causes weakening of the magnetic field, which may be desirable at high speeds.

For this purpose, the permanent magnet elements, at least in the area of the side of the permanent magnet elements remote from the air gap, may be mounted at the rotor on a layer of a material which is so selected that its modulus of elasticity induces a deformation of the rotor at high speeds in the sense of an increase of the air gap.

It is also possible to provide the rotor with structural weak points which enable its deformability in the radial direction, so that a deformation of the rotor in the sense of an increase of the air gap occurs at high speeds of the rotor.

A permanently excited electrical machine of the transversal flow machine type may have a stator and a rotor, with the stator comprising a coil arrangement and the rotor being provided with permanent magnet elements. Between the stator and the rotor an air gap is formed, which is defined by the permanent magnet elements and by magnetically conducting teeth of the stator, which in certain positions are oriented towards them. The coil arrangement has at least one preferably annular hollow cylindrical winding which is at least partially housed in the stator. The rotor is ironless and has a magnetic return which is formed by correspondingly oriented permanent magnet elements. Thereby, an ironless rotor is created, wherein axial magnetic fluxes (parallel to the longitudinal centre axis) in the rotor are effectively minimised or eliminated. As a consequence, parasitic losses due to induced eddy currents are also eliminated.

In all variants, the direction of orientation of the magnetic axis may be selected in such a manner that it includes an angle between approx. 20° and 80° with the radial direction, the vertex of which lies on the centre line of the permanent magnet elements.

### BRIEF DESCRIPTION OF THE DRAWINGS

Additional features, properties, advantages, and possible modifications will become apparent for those with skill in the art from the following description which refers to the accompanying drawings.

FIG. 1a is a schematic side view of a longitudinal section through an embodiment of a permanently excited electrical machine of the transversal flow machine type.

FIG. 1b is a schematic view of a short-circuit winding for the permanently excited electrical machine of the transversal flow machine type from FIG. 1a.

FIG. 2a is schematic end face view of a cross-section through a permanently excited electrical machine of the transversal flow machine type with two different configurations of permanent magnet elements.

FIG. 2b is schematic side plan view of a holding web of a rotor of a permanently excited electrical machine from FIG. 2a.

FIGS. 3a and 3b show rotor variants of an external rotor machine of the transversal flow machine type, which undergo deformation at high speeds of the rotor in the radial direction in the sense of an increase of the air gap.

### DETAILED DESCRIPTION OF THE DRAWINGS

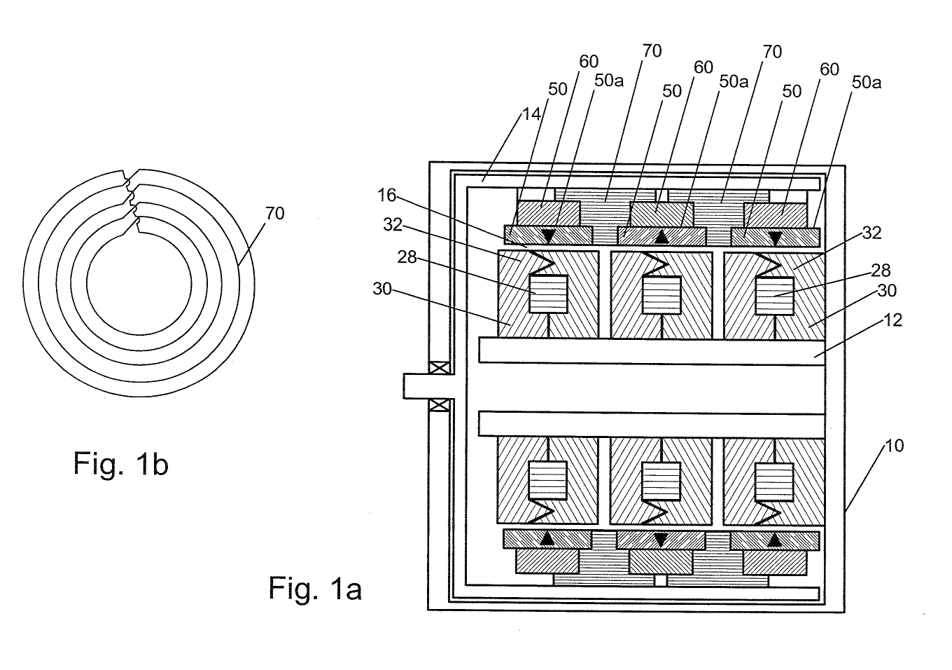

FIG. 1 shows a longitudinal section through an embodiment of a permanently excited electrical machine 10 of the transversal flow machine type with a claw-pole stator in an external rotor machine configuration. The illustrated concept which will be explained in the following may, however, also be employed for an internal rotor machine. The electrical machine 10 has a stator 12 and a rotor 14. An air gap 16 is formed between the rotor 14 and the stator 12. The stator 12 is surrounded by the cup-shaped rotor 14, from which it is separated by the air gap 16, which is provided with an output shaft now shown in detail at one end face. The bearing of the rotor by means of suitable ball or roller bearings is also illustrated only schematically.

The stator 12 has an essentially ring cylindrical coil arrangement 28 with two hollow cylindrical windings which are arranged coaxially to the common longitudinal centre axis M of the stator and the rotor of the transversal flow machine 10 with claw-pole stator. Each of the hollow cylindrical windings is wound from ribbon material with an essentially rectangular cross-section and accommodated in the stator 12.

In the present embodiment, the stator 12 is constructed of several parts, it may, however, also be designed as a single-part component. The/each winding of the coil arrangement 28 is/are surrounded by shell parts 30 which act as a magnetic flux yoke 30 and are approx. C-shaped in a sectional view along the longitudinal centre axis M of the coil arrangement. Each magnetic flux yoke 30 has a plurality of teeth 32 at the flank facing the rotor, which are oriented parallel to the longitudinal centre axis M. Two each magnetic flux yokes 30 encompass a winding from their respective end faces. Thus, in the case of an internal rotor machine, the teeth 32 of the magnetic flux yokes 30 are arranged at the inner surface of the hollow cylindrical windings, while in an external rotor machine, they are arranged at the outer surface of the hollow cylindrical windings. The otherwise essentially complementary magnetic flux yokes 30 which are associated with a corresponding winding are arranged in mutual engagement, with their respective teeth 32 being offset by half a tooth pitch.

Permanent magnet elements 50 of an alternating magnetic orientation towards the air gap 16 are arranged at the rotor 14 around the air gap 16 at a radial distance from the teeth 32. Their alternating polarity is indicated by the triangles which face radially inwards or outwards, respectively. In certain positions of the rotors 14 relative to the stator 12 the permanent magnet elements 50 of an axial row of the rotor 14 are in alignment with teeth 32 of an axial row of the stator 12. The permanent magnet elements of the rotor may be formed as castings or sheet metal blanks form an AINi or AINiCo alloy, from barium or strontium ferrite, from an SmCo or NdFeB alloy. In order to improve the mechanical stability, the permanent magnets may also be formed from powder particles which are embedded in temperature resistant plastic binders which include e.g. polyamide, polyphene sulfide, thermosetting plastic, epoxy resin, or the like. The plastic binder may also be methacrylate adhesive, epoxy resin adhesive, polyurethane adhesive, phenolic resin adhesive, fibre-reinforced epoxy resin or hydrophobised epoxy cast resin.

The permanent magnet elements 50 may have a shape which essentially corresponds to the shape of the teeth 32, i.e. they may therefore have a rectangular, trapezoidal or triangular or rhombic shape, respectively, or the like. In the direction of the longitudinal centre axis, the permanent magnet elements 50 may be approx. only half as long as the teeth 32 with which they are in alignment. Adjacent permanent magnet elements 50 in the direction of the longitudinal centre axis have a different magnetic orientation as well. This results in a chess board-like alternating arrangement of oppositely oriented permanent magnet elements 50.

At the sides 50a of the permanent magnet elements 50, which are remote from the air gap 16, the rotor 14 has a magnetic return 60 which is formed of rings oriented in the circumferential direction of the rotor 14a, made of a magnetically conductive material, e.g. soft iron. In the axial direction of the rotor 14, the rings are narrower, but by no means wider than individual one of the permanent magnet elements 50 which surround the rings.

Electrically/magnetically effective short-circuit coils 70—see FIG. 1b—of electrically conductive ribbon material, e.g. of copper or aluminium, are disposed between neighbouring permanent magnet elements 50 in the axial direction of the electrical machine 10 and neighbouring magnetic return rings 60 in the axial direction.

Instead of wound short-circuit coils, tubular short-circuit sleeves may be arranged in the radial direction on the side of the permanent magnet elements 50 or of the magnetic return 60, respectively, which is remote from the air gap 16. Instead of several short-circuit sleeves at each of the permanent magnet elements 50 or of the magnetic returns 60, respectively, a continuous tubular short-circuit sleeve may be provided. This continuous tubular short-circuit sleeve may also in part or completely assume the function of the rotor carrier.

In the illustrated variant, the short-circuit coils 70 are protruding beyond the magnetic return rings 60 in the radial direction and bear against the rotor inner wall.

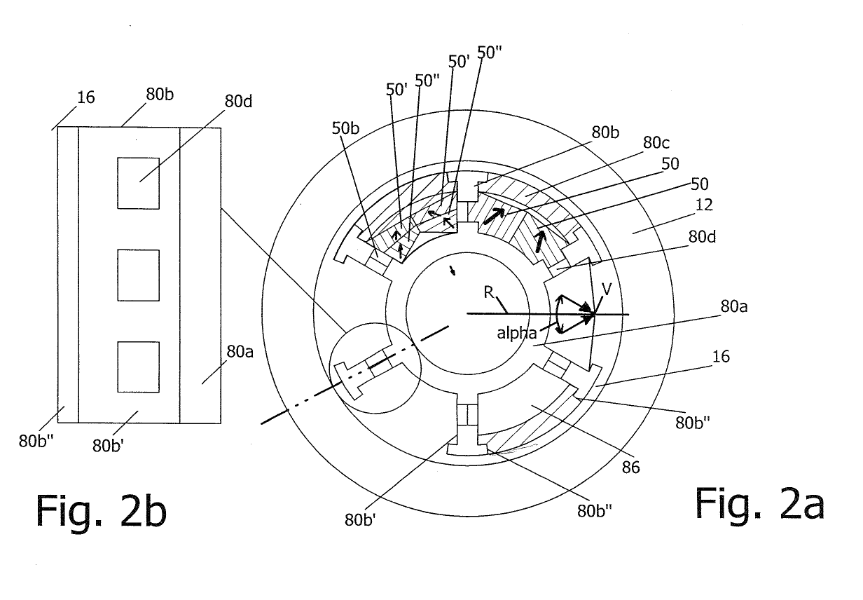

As a variant to FIGS. 1a, 1b, FIG. 2 illustrates a permanently-excited electrical machine 10 of the transversal flow machine type comprising a claw-pole stator with a similarly designed stator 12 (shown schematically only) and a rotor 14 as an internal rotor configuration. Components with the same effect, structure, and/or function as those of FIGS. 1a, 1b are identified by the same reference numerals, so that a repeated detailed description of them may be omitted.

In this variant, too, of the permanently-excited electrical machine of the transversal flow machine type, the stator has a coil arrangement and the rotor is provided with permanent magnet elements. An air gap is formed between the stator and the rotor, which is defined by the permanent magnet elements and by magnetically conductive stator teeth which, in certain positions, are aligned with them. The rotor has a multi-piece magnetically non-effective support structure 80a, 80b, 80c for the permanent magnet elements 50 and the permanent magnet elements 50. The support structure has a carrier tube 80a at whose outer circumference radially projecting equally spaced holding webs 80b are formed along the circumference. In a face end plan view (see FIG. 2a), the holding webs 80b are essentially T-shaped, with rectangularly formed recesses 80d being provided in their radially oriented web portions 80b′ (see FIG. 2b), into which the correspondingly shaped pins 50b of the permanent magnet elements 50 engage.

The arrows shown in the permanent magnet elements 50 indicate the magnetic orientation. At the free ends of the holding webs 80b, which face the air gap 16, holding protrusions 80b″ are provided which are oriented in the tangential direction. Two each holding protrusions 80b″ facing one another of neighbouring holding webs 80b accommodate a curved holding plate 80c with correspondingly shaped edge areas. Together with the curved holding plate 80c, the carrier tube 80a and two each holding webs 80b, which radially project from its outer circumference, form an installation space 86 for the permanent magnet elements 50. The rotor or the support structure, respectively, is made form a magnetically non-effective or almost non-effective material. Thus, the rotor has no magnetic return. In place of the curved holding plate 80c, the holding protrusions 80b″ which are oriented in the tangential direction may project to such an extent, that they are able to assume the holding function for the permanent magnet elements 50 alone.

In the variant shown in FIG. 2a, the permanent magnet elements 50 are designed in a “sub-variant” on the left side as radially divided elements 50′, 50″, while the permanent magnet elements 50 on the right side are undivided, i.e. integral, in the radial direction. This division of the permanent magnet elements 50 enables a particularly advantageous path of the magnetic flux, and thus results in an only minimum leakage flux. It is understood that all permanent magnet elements 50 in an electrical machine are configured alike, i.e. either as divided or undivided elements.

In place of the multi-part permanent magnet elements 50, a monolithic magnet formed body may be used, onto which the magnetic orientation which changes in its volume has been imprinted or forced upon by a corresponding magnetisation.

The holding elements 80b, 80c facing the air gap may also be magnetically conductive and consist, e.g. of soft iron.

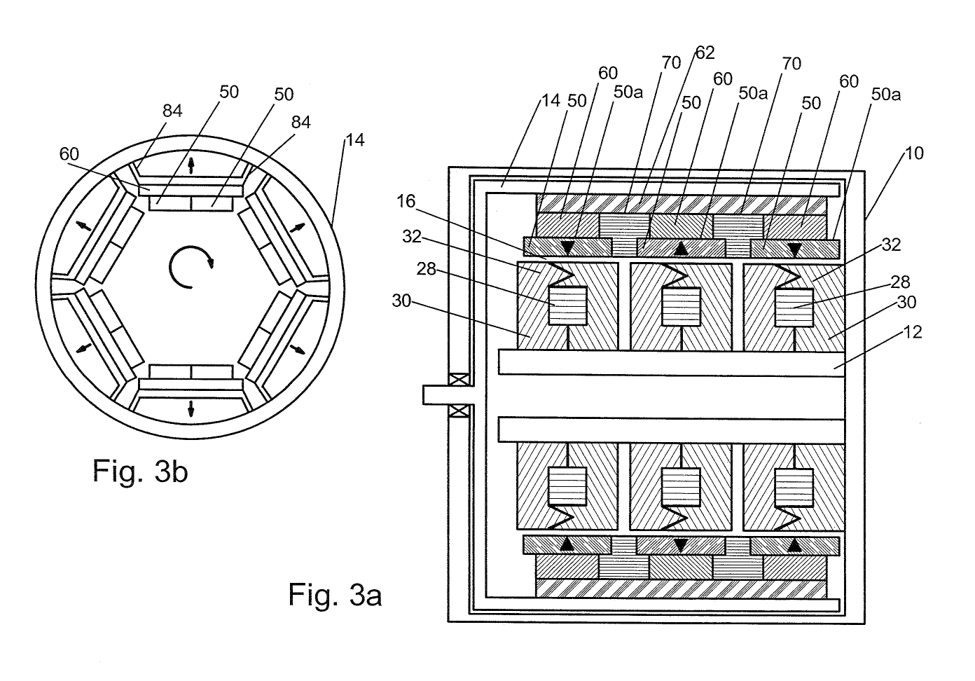

In FIG. 3a shows a rotor 14 of an external rotor machine of the transversal flow machine type, wherein the rotor 14 carrying the permanent magnet elements 50 undergoes a deformation in the radial at high speeds of the rotor 14 in the sense of an increase of the air gap 16. For this purpose, the permanent magnet elements 50 are secured at the rotor 14 via a resilient material strip of e.g. caoutchouc or the like. The material is selected in such a manner that, depending on its shape and/or its modulus of elasticity, a deformation at high speeds of the rotor 14 occurs in the sense of an increase of the air gap 16. FIG. 3b shows how in addition or in place of this measure, the rotor 14 of an external rotor machine of the transversal flow machine type is provided with structural weak points 84 which enable its deformability in the radial direction, so that a deformation of the rotor 14 occurs at high speeds of the rotor in the sense of an increase of the air gap 16—in the direction of the radial arrows in FIG. 3b. The direction of the orientation of the magnetic axis is so selected in all the illustrated variants that it includes an angle between approx. 20° and 80° with the radial direction, whose vertex V lies in the centre of the permanent magnet elements 50.

The relationships of the individual parts and portions of the transversal flow machine with a claw-pole stator illustrated in the figures as well as their dimensions and proportions are not to be understood as limiting. Rather, individual dimensions and proportions may differ from those shown. Moreover, individual aspects of the various variants of the transversal flow machine may be combined, without being shown herein in detail.

1-13. (canceled)

14. A permanently-excited electrical machine of the transversal flow machine type comprising a claw-pole stator, with a stator and a rotor, wherein the stator comprises an essentially annular coil arrangement with a centre axis which essentially coincides with a longitudinal centre axis of the transversal flow machine, and wherein the rotor is provided with permanent magnet elements, an air gap is formed between the stator and the rotor, which is defined by the permanent magnet elements and by magnetically conductive teeth of the stator, which in certain positions are aligned with these, a coil arrangement comprises at least one hollow cylindrical winding which is at least partially accommodated in stator, and the rotor is ironless and wherein a magnetic return is formed by correspondingly oriented permanent magnet elements, and the permanent magnet elements effectively minimise axial magnetic fluxes parallel to the longitudinal centre axis.

15. The permanently-excited electrical machine according to claim 14, wherein the direction of orientation of the magnetic axis is selected in such a manner that it includes an angle (alpha) between approx. 20° and 80° with the radial direction R, whose vertex lies on the centre line of the permanent magnet elements.

16. A permanently-excited electrical machine of the transversal flow machine type comprising a claw-pole stator, with a stator and a rotor, wherein the stator comprises an essentially annular coil arrangement with a centre axis which essentially coincides with a longitudinal centre axis of the rotor, and wherein the rotor is provided with permanent magnet elements, an air gap is formed between the stator and the rotor, which is defined by the permanent magnet elements and by magnetically conductive teeth of the stator, which in certain positions are aligned with these, a coil arrangement comprises at least one hollow cylindrical winding which is at least partially accommodated in stator, and the rotor has a magnetic return on the sides of the permanent magnet elements which are remote from the air gap, and is formed by rings oriented in the circumferential direction of the rotor and which, in the axial direction of the rotor are not wider than individual ones of the permanent magnet elements, and tubular short-circuit sleeves arranged in the radial direction on the side of the permanent magnet elements or of the magnetic return, respectively, which is remote from the air gap, or between neighbouring permanent magnet elements in the axial direction of the electrical machine, and/or neighbouring magnetic return rings in the radial direction are arranged between electrically/magnetically effective short-circuit coils.

17. The permanently-excited electrical machine according to claim 16, wherein the short-circuit coils are made of ribbon material of good electrical conductivity containing copper, aluminium or the like.

18. The permanently-excited electrical machine according to claim 16, wherein the short-circuit coils project beyond the magnetic return rings in the radial direction.

19. A permanently-excited electrical machine of the transversal flow machine type comprising a claw-pole stator, with a stator and a rotor, wherein the stator comprises an essentially annular coil arrangement with a centre axis which essentially coincides with a longitudinal centre axis of the rotor, and wherein the rotor is provided with permanent magnet elements, an air gap is formed between the stator and the rotor, which is defined by the permanent magnet elements and by magnetically conductive teeth of the stator, which in certain positions are aligned with these, wherein a coil arrangement comprises at least one hollow cylindrical winding which is at least partially accommodated in stator, and the rotor comprises a magnetically non-effective support structure for the permanent magnet elements and the permanent magnet elements, wherein the magnetically non-effective support structure is formed from several components to be fitted together.

20. The permanently-excited electrical machine according to claim 19, wherein the magnetically non-effective support structure is formed at least partially from an electrically conductive ribbon material which contains copper, aluminium, titanium, or the like.

21. The permanently-excited electrical machine according to claims 19, wherein the magnetically non-effective support structure is formed at least partially from an electrical insulator such as plastic material or the like.

22. The permanently-excited electrical machine according to claim 14, 16 or 19, wherein the permanent magnet elements are formed as components which comprise sintered or plastic-bonded permanent magnet particles.

23. A permanently-excited electrical machine of the transversal flow machine type comprising a claw-pole stator, with a stator and a rotor in an external rotor configuration, wherein the stator comprises a coil arrangement and the rotor is provided with permanent magnet elements, an air gap is formed between the stator and the rotor, which is defined by the permanent magnet elements and by magnetically conductive teeth of the stator, which in certain positions are aligned with these, wherein the coil arrangement comprises at least one hollow cylindrical winding which is at least partially accommodated in stator, the rotor is provided with structural weak points, so that a deformation of the rotor occurs at high speeds of the rotor in the sense of an increase of the air gap, and a magnetic return is provided in the rotor.
